(19) United States
(12) Patent Application Publication
(10) Pub. No.: US 2010/0052646 A1
(43) Pub. Date: Mar. 4, 2010

(54) CURRENT MIRROR WITH IMMUNITY FOR THE VARIATION OF THRESHOLD VOLTAGE AND THE GENERATION METHOD THEREOF

(76) Inventors: Chun Shiah, Hsinchu City (TW); Hao-Jan Yang, Yunlin County (TW); Ho-Yin Chen, Hsinchu County (TW); Kuo-Chen Lai, Changhua County (TW)

Correspondence Address: NORTH AMERICA INTELLECTUAL PROPERTY CORPORATION, P.O. BOX 506, MERRIFIELD, VA, 22116, US

(21) Appl. No.: 12/471,403

(22) Filed: May 24, 2009

(30) Foreign Application Priority Data
Aug. 28, 2008 (TW) 097132956

(51) Int. Cl. G05F 3/16

(52) U.S. Cl. 323/315

(57) ABSTRACT

A current mirror with immunity for the variation of threshold voltage includes raising the voltage difference between the gate and the source of a MOS in the current source, and increasing the channel length of the MOS for limiting the generated reference current.

### BACKGROUND OF THE INVENTION

1. Field of the Invention

The present invention relates to a current source with immunity for the variation of threshold voltage, and more particularly, to a current source for lowering the impact of the threshold voltage on the magnitude of the current, by increasing the voltage difference between the gate and the source of the current source.

2. Description of the Prior Art

Please refer to FIG. 1. FIG. 1 is a diagram illustrating a conventional current mirror. As shown in FIG. 1, the gate (control end) of the P-type Metal Oxide Semiconductor (PMOS) transistor Q_{P1} is utilized to receive a control voltage V_{G}, the source (first end) of the PMOS transistor Q_{P1} is coupled to a voltage source V_{DD}, and the drain (second end) of the PMOS transistor Q_{P1} is utilized to output a current I₁. The gate (control end) of the PMOS transistor Q_{P2} is utilized to receive the control voltage V_{G}, the source (first end) of the PMOS transistor Q_{P2} is coupled to the voltage source V_{DD}, and the drain (second end) of the PMOS transistor Q_{P2} is utilized to output a current I₂. The conventional current mirror utilizes the control voltage V_{G} to bias the PMOS transistor Q_{P1} for generating the reference current source I₁, and then the ratio of the channel aspect ratios (width/length, W/L) of the PMOS transistors Q_{P1} and Q_{P2} is utilized to generate the current I₂, which is proportional to the reference current source I₁. For instance, if the channel aspect ratio (W₁/L₁) of the PMOS transistor Q_{P1} is “1” and the channel aspect ratio (W₂/L₂) of the PMOS transistor Q_{P2} is “2”, then when the reference current source I₁ is 1 amp, the current I₂ is generated to be 2 amps.

The conventional current mirror operates the PMOS transistor Q_{P1} in the saturation region. In other words, the relationship between the current 11 and the voltage V_{G} is described in the formulas as below:

I₁=1/2×K×(W₁/L₁)×(V_{SG}−V_{T})² (1);

=1/2×K×(W₁/L₁)×(V_{DD}−V_{G}−V_{T})² (2);

where the voltage V_{SG} represents the voltage difference, which is equivalent to the voltage of (V_{DD}−V_{G}), between the source and the gate of the PMOS transistor Q_{P1}, the voltage V_{T} represents the threshold voltage of the PMOS transistor Q_{P1}, and K represents a process variable. Hence, the magnitude of the reference current source I₁ is related to the channel aspect ratio (W₁/L₁) of the PMOS transistor Q_{P1}, the voltage difference V_{SG} (equivalent to (V_{DD}−V_{G})), and the threshold voltage V_{T}.

Due to the magnitude of the threshold voltage V_{T} is easily affected by the processing, when under different processing, the magnitude of the current source I₁ is still affected by the threshold voltage V_{T}, even with the same voltage source V_{DD}, the same voltage difference V_{SG} between the source and the gate, and the same channel aspect ratio (W/L). In this way, the magnitude of the current source differs from the desired.

### SUMMARY OF THE INVENTION

The present invention provides a current source for driving a first Metal Oxide Semiconductor (MOS) transistor to generate a predetermined current. The current source comprises a feedback circuit. The feedback circuit comprises a second MOS transistor, a third MOS transistor, a fourth MOS transistor, a fifth MOS transistor, a first resistor coupled between the ground end and the control end of the fifth MOS transistor, and a MOS circuit. The second MOS transistor comprises a first end coupled to a voltage source, a control end, and a second end coupled to the control end of the second MOS transistor. The third MOS transistor comprises a first end coupled to the voltage source, a control end coupled to the control end of the second MOS transistor, and a second end. The fourth MOS transistor comprises a first end coupled to the second end of the third MOS transistor, a control end for receiving a control voltage, and a second end coupled to a ground end. The fifth MOS transistor comprises a first end coupled to the second end of the second MOS transistor, a control end for outputting the control voltage, and a second end coupled to the ground end. The MOS circuit comprises a first end coupled to the voltage source, a control end coupled to the first end of the fourth MOS transistor, and a second end coupled to the control end of the fifth MOS transistor.

The present invention further provides a current source. The current source comprises a first MOS transistor for generating a predetermined current, a feedback circuit, a first resistor coupled to a ground end and the output end of the feedback circuit, and a MOS circuit. The feedback circuit comprises a first end coupled to a voltage source, a control end for receiving a control voltage, an output end for outputting the control voltage, and a feedback end coupled to a control end of the first MOS transistor. The MOS circuit comprises a first end coupled to the voltage source, a control end coupled to the feedback end of the feedback circuit, and a second end coupled to the output end of the feedback circuit.

The present invention further provides a method for generating current with immunity for variation of threshold voltage. The method comprises providing a first MOS transistor for a first end of the first MOS transistor to be coupled to a voltage source, providing a MOS transistor circuit to be coupled to the first MOS transistor and the voltage source, providing a feedback circuit to be coupled to the voltage source, and inputting a control voltage to the feedback circuit for control a current with a predetermined magnitude passing through the MOS transistor circuit, as well as control a voltage of the feedback end, wherein the feedback end is coupled to a control end of the first MOS transistor. The feedback circuit comprises a feedback end coupled between the MOS transistor circuit and the first MOS transistor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional current mirror.

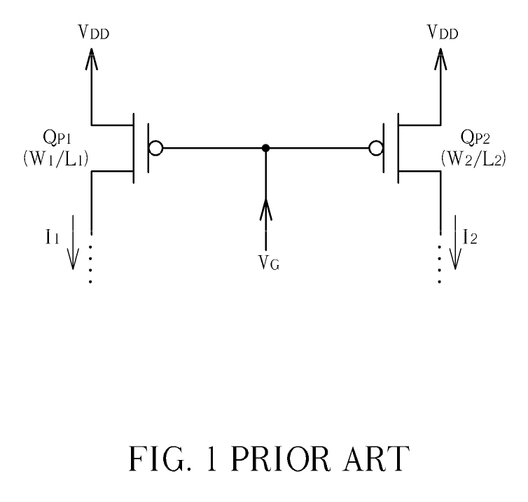

FIG. 2 is a diagram illustrating the current source 200 for reducing the affect of the threshold voltage according to the first embodiment of the present invention.

FIG. 3 is a diagram illustrating the current source 300 for reducing the impact of the threshold voltage according to the second embodiment of the present invention.

FIG. 4 is a diagram illustrating the current source 400 for reducing the impact of the threshold voltage according to the third embodiment of the present invention.

FIG. 5 is a flowchart illustrating a method 500 of generating the current with immunity to the variation of the threshold voltage of the present invention.

### DETAILED DESCRIPTION

Hence, the present invention raises the voltage difference V_{SG} between the source and the gate of the MOS transistor for reducing the impact of varying the threshold voltage V_{T}, according to formulas (1) and (2) of the current of the MOS transistor operating in the saturation region. However, to keep the reference current source I₁ generating a fixed current without changing the process variable K, the channel aspect ratio (W/L) of the MOS transistor needs to be reduced in order to keep the current of the reference current source I₁ in the same range.

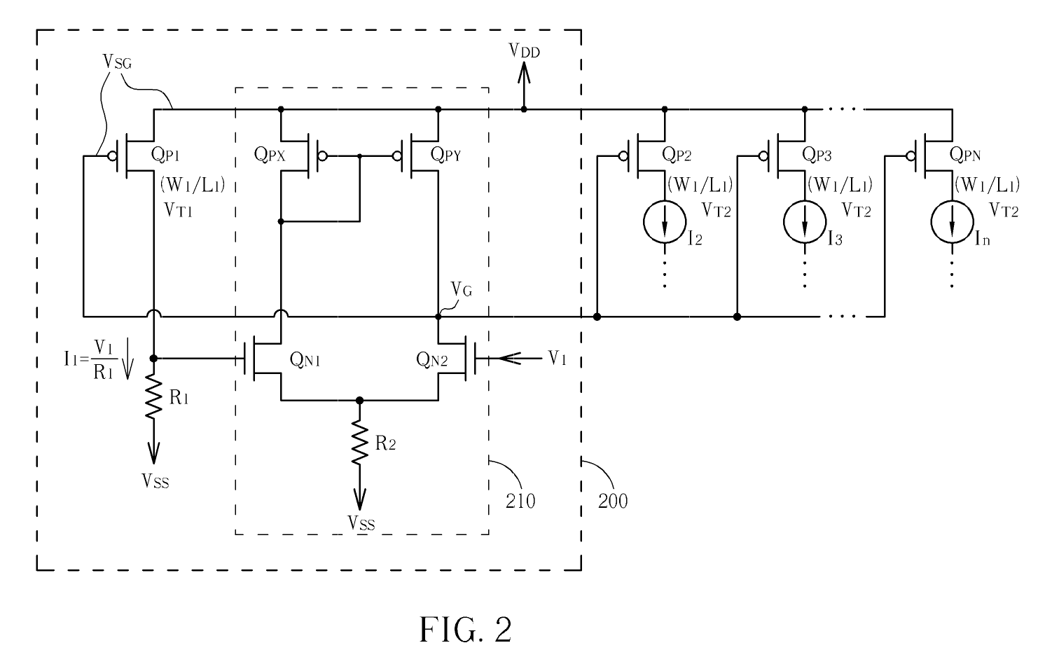

Please refer to FIG. 2. FIG. 2 is a diagram illustrating the current source 200 for reducing the affect of the threshold voltage according to the first embodiment of the present invention. The current source 200 comprises a feedback circuit 210, a PMOS transistor Q_{P1}, and a resistor R₁. The feedback circuit 210 comprises two PMOS transistors Q_{PX} and Q_{PY}, two N-channel Metal Oxide Semiconductor (NMOS) transistors Q_{N1} and Q_{N2}, and a resistor R₂. The current source 200 enables the PMOS transistors Q_{P2}, Q_{P3} . . . Q_{PN} to replicate the currents I₂, I₃ . . . I_{N}, in proportion to the magnitude of the reference current source I₁.

In the feedback circuit 210, the source (first end) of the PMOS transistor Q_{PX} is coupled to the voltage source V_{DD}, the gate (control end) of the PMOS transistor Q_{PX} is coupled to the drain (to ensure operation in the saturation region) of the PMOS transistor Q_{PX}, and the drain (second end) of the PMOS transistor Q_{PX} is coupled to the drain (first end) of the NMOS transistor Q_{N1}. The source (first end) of the PMOS transistor Q_{PY} is coupled to the voltage source V_{DD}, the gate (control end) of the PMOS transistor Q_{PY} is coupled to the gate of the PMOS transistor Q_{PX}, and the drain (second end) of the PMOS transistor Q_{PY} is coupled to the drain (first end) of the NMOS transistor Q_{N2}. The source (second end) of the NMOS transistor Q_{N1} is coupled to the resistor R₂, the gate (control end) of the NMOS transistor Q_{N1} is coupled to the resistor R₁, and the drain (first end) of the NMOS transistor Q_{N1} is coupled to the drain of the PMOS transistor Q_{PX}. The source (second end) of the NMOS transistor Q_{N2} is coupled to the resistor R₂, the gate (control end) of the NMOS transistor Q_{N2} is utilized to receive a control voltage V₁, and the drain (first end) of the NMOS transistor Q_{N2} is coupled to the drain of the PMOS transistor Q_{PY}. The resistor R₂ is coupled between the NMOS transistors Q_{N1} and Q_{N2}, and the ground end (V_{SS}).

In the current source 200, the source (first end) of the PMOS transistor Q_{P1} is coupled to the voltage source V_{DD}, the gate (control end) of the PMOS transistor Q_{P1} is coupled to the drain (first end) of the NMOS transistor Q_{N2} of the feedback circuit 210, and the drain (second end) of the PMOS transistor Q_{P1} is coupled to the resistor R₁. The resistor R₁ is coupled between the drain of the PMOS transistor Q_{P1}, the gate (control end) of the NMOS transistor Q_{N1}, and the ground end. In this way, the voltage across the resistor R₁ equals the control voltage V₁. Hence the magnitude of the reference current source I₁ is limited by the control voltage V₁ and the resistance of the resistor R₁ (I₁=V₁/R₁). Therefore, the feedback circuit 210 controls the magnitude of the voltage difference V_{SG} according to the magnitude of the control voltage V_{G} for stabilizing the reference current source I₁ at (V₁/R₁) with the negative feedback manner.

In the first embodiment of the present invention, the threshold voltage V_{T1} of the PMOS transistor Q_{P1} is designed to be significantly higher than the threshold voltage V_{T2} of the PMOS transistors Q_{P2}˜Q_{PN}. Hence, under the condition that the reference current source I₁ is fixed and the channel aspect ratio (W₁/L₁) of the PMOS transistors Q_{P1}˜Q_{PN} is fixed, the voltage V_{SG} across the PMOS transistor Q_{P1} is relatively larger than those of the PMOS transistors Q_{P2}˜Q_{PN} such that the replicated currents I₂˜I_{N} can be unaffected by the threshold voltage V_{T2}. More particularly, when the threshold voltage V_{T1} equals to the threshold voltage V_{T2}, the voltage V_{SG} across the PMOS transistor Q_{P1} can not be raised (when the magnitude of the reference current source I₁ is fixed to (V₁/R₁), and the channel aspect ratio (W₁/L₁) of the PMOS transistors Q_{P1}˜Q_{PN} is also fixed), according to formula (1): I₁=1/2×K×(W₁/L₁)×(V_{SG}×V_{T1})². Hence, the first embodiment of the present invention demonstrates that increasing the threshold voltage V_{T1} increases the voltage difference V_{SG} accordingly. In FIG. 2, as the voltage V_{G} decreases, the voltage V_{SG} across the PMOS transistors Q_{P2}˜Q_{PN} increases accordingly. Also, due to the threshold voltage V_{T2} of the PMOS transistors Q_{P2}˜Q_{PN} is designed to be relatively smaller than the threshold voltage V_{T1}, the variance of the threshold voltage V_{T2} has less impact on the raised voltage V_{SG}, consequently causing the replicated currents I₂˜I_{N} to be controlled within a desired range.

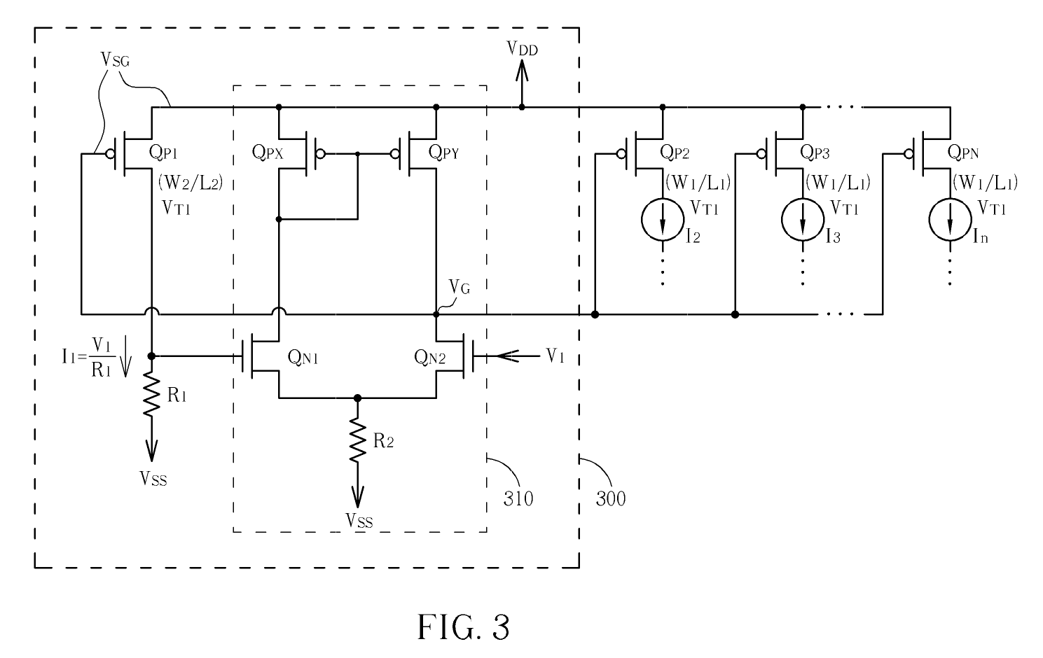

Please refer to FIG. 3. FIG. 3 is a diagram illustrating the current source 300 for reducing the impact of the threshold voltage according to the second embodiment of the present invention. The current source 300 comprises a feedback circuit 310, a PMOS transistor Q_{P1}, and a resistor R₁. The feedback circuit 310 comprises two PMOS transistors Q_{PX} and Q_{PY}, two NMOS transistors Q_{N1} and Q_{N2}, and a resistor R₂. The current source 300 enables the PMOS transistors Q_{P2}, Q_{P3} . . . Q_{PN} to replicate currents I₂, I₃ . . . I_{N}, in proportion to the magnitude of the reference current source I₁.

Differed from the first embodiment, in the second embodiment of the present invention, the threshold voltages of the PMOS transistors Q_{P1}˜Q_{PN} are designed to be as the same as the threshold voltage V_{T1}, and the channel aspect ratio (W₂/L₂) of the PMOS transistor Q_{P1} is designed to be significantly lowered than the channel aspect ratios of the PMOS transistor Q_{P2}˜Q_{PN}. Hence, under the condition that the magnitude of the reference current source I₁ is fixed and the channel aspect ratio (W₂/L₂) of the PMOS transistor Q_{P1} is significantly lower than the channel aspect ratio (W₁/L₁) of the PMOS transistors Q_{P2}˜Q_{PN}, the voltage V_{SG} across the PMOS transistor Q_{P1} can be raised such that the replicated currents I₂˜I_{N} can be unaffected by the threshold voltage V_{T1}. More particularly, when the channel aspect ratio (W₂/L₂) equals to the channel aspect ratio (W₁/L₁), the voltage V_{SG} across the PMOS transistor Q_{P1} cannot be raised (when the magnitude of the reference current source I₁ is fixed to (V₁/R₁) and the channel aspect ratio (W₁/L₁) of the PMOS transistors Q_{P1}˜Q_{PN} is also fixed), according to formula (1): I₁=1/2×K×(W₁/L₁)×(V_{SG}−V_{T1})². When the channel aspect ratio is reduced to (W₂/L₂), the voltage V_{SG} across the PMOS transistor Q_{P1} can be raised to keep the reference current source I₁ to be fixed to (V₁/R₁), according to formula (1): I₁=1/2×K×(W₂/L₂)×(V_{SG}−V_{T1})². Hence, the second embodiment of the present invention demonstrates that decreasing the channel aspect ratio of the PMOS transistor Q_{P1} increases the voltage difference V_{SG}. As shown in FIG. 3, as the voltage difference V_{SG} decreases, the voltage V_{SG} across the PMOS transistors Q_{P2}˜Q_{PN} increases and the variance of the threshold voltage V_{T1} of the PMOS transistors Q_{P2}˜Q_{PN} has less impact on the raised voltage V_{SG}, consequently causing the replicated currents I₂˜I_{N} to be controlled within a desired range.

In addition, there are two ways to lower the channel aspect ratio of the PMOS transistor Q_{P1}; one way is to increase the channel length of the PMOS transistor Q_{P1}, causing the channel aspect ratio of the PMOS transistor Q_{P1} to decrease accordingly; the other way is to decrease the channel width of the PMOS transistor Q_{P1}, causing the channel aspect ratio to decrease accordingly.

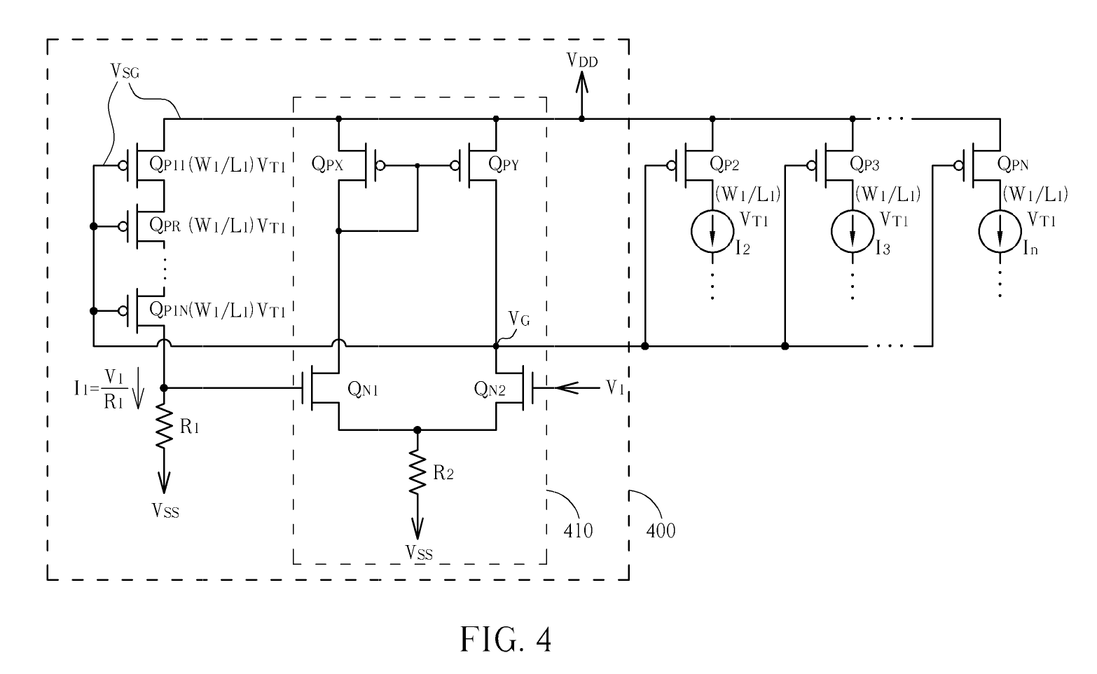

Please refer to FIG. 4. FIG. 4 is a diagram illustrating the current source 400 for reducing the impact of the threshold voltage according to the third embodiment of the present invention. The current source 400 comprises a feedback circuit 410, N PMOS transistors Q_{P11}˜Q_{P1N}, and a resistor R₁. The feedback circuit 41 0 comprises two PMOS transistors Q_{PX} and Q_{PY}, two NMOS transistors Q_{N1} and Q_{N2}, and a resistor R₂. The current source 400 enables the PMOS transistors Q_{P2}, Q_{P3} . . . Q_{PN} to replicate currents I₂, I₃ . . . I_{N}, in proportion to the magnitude of the reference current source I₁.

In the current source 400, the PMOS transistor Q_{P1} of the first embodiment of FIG. 2 is replaced by N PMOS transistors Q_{P11}˜Q_{P1N}. In the current source 400, the source (first end) of the PMOS transistor Q_{P11} is coupled to the voltage source V_{DD}, the gate (control end) of the PMOS transistor Q_{P11} is coupled to the drain (first end) of the NMOS transistor Q_{N2} of the feedback circuit 410, and the drain (second end) of the PMOS transistor Q_{P11} is coupled to the source (first end) of the PMOS transistor Q_{P12}; the source (first end) of the PMOS transistor Q_{P12} is coupled to the drain of the of the PMOS transistor Q_{P11}, the gate (control end) of the PMOS transistor Q_{P12} is coupled to the drain (first end) of the NMOS transistor Q_{N2} of the feedback circuit 410, and the drain (second end) of the PMOS transistor Q_{P12} is coupled to the source (first end) of the PMOS transistor Q_{P13} . . . , and so on; the source (first end) of the PMOS transistor Q_{P1N} is coupled to the drain of the PMOS transistor Q_{P1(N-1)}, the gate (control end) of the PMOS transistor Q_{P1N} is coupled to the drain (first end) of the NMOS transistor Q_{N2} of the feedback circuit 410, and the drain (second end) of the PMOS transistor Q_{P1N} is coupled to the resistor R₁. The resistor R₁ is couple between the drain of the PMOS transistor Q_{P1N}, the gate (control end) of the NMOS transistor Q_{N1}, and the ground end. Hence, the voltage across the resistor R₁ also equals the control voltage V₁. Hence, the magnitude of the reference current source I₁ is limited to (V₁/R₁). Therefore, the feedback circuit 410 controls the magnitude of the voltage difference V_{SG} according to the magnitude of the control voltage V_{G} for stabilizing the reference current source I₁ at (V₁/R₁) with the negative feedback manner.

In the third embodiment of the present invention, the threshold voltage of the PMOS transistor Q_{P11}˜Q_{P1N} and Q_{P2}˜Q_{PN} are designed to have the same as the threshold voltage V_{T1} and the same channel aspect ratio (W₁/L₁). Since the PMOS transistors Q_{P11}˜Q_{P1N} are connected in series, the serial-connected PMOS transistors Q_{P11}˜Q_{P1N} can be equivalent to a single PMOS transistor, with an effective channel length of a multiple of N. In other words, in the equivalent MOS transistor, the channel aspect ratio changes to a multiple of 1/N (which implies decreasing to a multiple of 1/N). Hence, effectively speaking, the third embodiment of the present invention is similar to the second embodiment of the present invention in terms of lowering the channel aspect ratio to increase the voltage difference V_{SG}. In other words, under the condition that the reference current source I₁ is kept constant and the channel aspect ratio (W₁/NL₁) of the PMOS transistors Q_{P11}˜Q_{P1N} is significantly lower than the channel aspect ratios (W₁/L₁) of the PMOS transistors Q_{P2}˜Q_{PN}, the voltage V_{SG} across the PMOS transistors Q_{P11}˜Q_{PN} can be raised, consequently avoiding the replicated currents I₂˜I_{N} being affected by the threshold voltage V_{T1} and being controlled within a desired range.

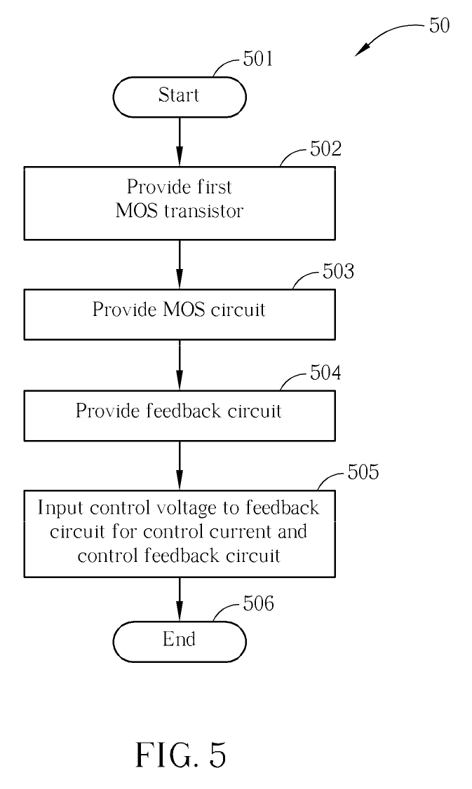

Please refer to FIG. 5. FIG. 5 is a flowchart illustrating a method 500 of generating the current with immunity to the variation of the threshold voltage of the present invention. The steps of the method are explained below:

Step 510: Start;

Step 502: Provide a first MOS transistor to be coupled to a voltage source;

Step 503: Provide a MOS circuit to be coupled to the first MOS transistor and the voltage source;

Step 504: Provide a feedback circuit to be coupled to the voltage source, wherein the feedback circuit comprises a feedback end coupled between the MOS circuit and the first MOS transistor;

Step 505: Input a control voltage to the feedback circuit for control a current with a predetermined magnitude passing through the MOS circuit, as well as control a voltage of the feedback end;

Step 506: End.

In step 503, the MOS transistor comprises a sixth MOS transistor. The channel aspect ratio of the sixth MOS transistor can be adjusted to be lower than the channel aspect ratio of the first MOS transistor, or, the threshold voltage of the sixth MOS transistor can be adjusted to be higher than the threshold voltage of the first MOS transistor.

In step 503, the MOS circuit can also be realized with a plurality of MOS transistors connected in series. The channel aspect ratio of every MOS transistor of the plurality of MOS transistors connected in series can be adjusted to approximately equal to the channel aspect ratio of the first MOS transistor.

To sum up, the current source and the method for generating the current of the present invention can effectively resist the impact of the variation of the threshold voltage during processing to the current stability, providing great convenience.

Those skilled in the art will readily observe that numerous modifications and alterations of the device and method may be made while retaining the teachings of the invention.

What is claimed is:

1. A current source, for driving a first Metal Oxide Semiconductor (MOS) transistor to generate a predetermined current, the current source comprising:
a feedback circuit, comprising:
a second MOS transistor, comprising:
a first end, coupled to a voltage source;
a control end; and
a second end, coupled to the control end of the second MOS transistor;
a third MOS transistor, comprising:
a first end, coupled to the voltage source;
a control end, coupled to the control end of the second MOS transistor; and
a second end;
a fourth MOS transistor, comprising:
a first end, coupled to the second end of the third MOS transistor;
a control end, for receiving a control voltage; and
a second end, coupled to a ground end; and
a fifth MOS transistor, comprising:
a first end, coupled to the second end of the second MOS transistor;
a control end, for outputting the control voltage; and
a second end, coupled to the ground end;
a first resistor, coupled between the ground end and the control end of the fifth MOS transistor; and
a MOS circuit, comprising:
a first end, coupled to the voltage source;
a control end, coupled to the first end of the fourth MOS transistor; and
a second end, coupled to the control end of the fifth MOS transistor.

2. The current source of claim 1, wherein the MOS circuit comprises a sixth MOS transistor; threshold voltage of the sixth MOS transistor is higher than threshold voltage of the first MOS transistor.

3. The current source of claim 1, wherein the MOS circuit comprises a sixth MOS transistor; the first, second, third and sixth MOS transistors are P-type Metal Oxide Semiconductor (PMOS) transistors.

4. The current source of claim 1, wherein the MOS circuit comprises a sixth MOS transistor; channel aspect ratio of the sixth MOS transistor is lower than channel aspect ratio of the first MOS transistor.

5. The current source of claim 1, wherein the fourth and fifth MOS transistors are N-type Metal Oxide Semiconductor (NMOS) transistors.

6. The current source of claim 1, further comprising a resistor, coupled between the second end of the fourth MOS transistor, the second end of the fifth MOS transistor, and the ground end.

7. The current source of claim 1, wherein the MOS circuit comprises a plurality of MOS transistors connected in series; a control end of each MOS transistor is coupled to the control end of the MOS circuit, a first end of a sixth MOS transistor of the plurality of MOS transistors connected in series is coupled to the first end of the MOS circuit, and a second end of a seventh MOS transistor of the plurality of MOS transistors connected in series is coupled to the second end of the MOS circuit.

8. The current source of claim 7, wherein the channel aspect ratio of each MOS transistor of the plurality of MOS transistors connected in series is approximately equal to the channel aspect ratio of the first MOS transistor.

9. The current source of claim 7, wherein threshold voltage of each MOS transistor of the plurality of MOS transistors connected in series is approximately equal to the threshold voltage of the first MOS transistor.

10. A current source, comprising:
a first MOS transistor for generating a predetermined current;
a feedback circuit, comprising:
a first end, coupled to a voltage source;
a control end, for receiving a control voltage;
an output end, for outputting the control voltage; and
a feedback end, coupled to a control end of the first MOS transistor;
a first resistor, coupled to a ground end and the output end of the feedback circuit; and
a MOS circuit, comprising:
a first end, coupled to the voltage source;
a control end, coupled to the feedback end of the feedback circuit; and
a second end, coupled to the output end of the feedback circuit.

11. The current source of claim 10, wherein the MOS circuit comprises a sixth MOS transistor; threshold voltage of the sixth MOS transistor is higher than threshold voltage of the first MOS transistor.

12. The current source of claim 10, wherein the MOS circuit comprises a sixth MOS transistor; aspect ratio of the sixth MOS transistor is lower than aspect ratio of the first MOS transistor.

13. The current source of claim 10, further comprising a resistor coupled between a second end of the feedback circuit and the ground end.

14. The current source of claim 10, wherein the MOS circuit comprises a plurality of MOS transistors connected in series; a control end of each MOS transistor is coupled to the control end of the MOS circuit, a first end of a sixth MOS transistor of the plurality of MOS transistors connected in series is coupled to the first end of the MOS circuit, and a second end of a seventh MOS transistor of the plurality of MOS transistors connected in series is coupled to the second end of the MOS circuit.

15. The current source of claim 14, wherein the channel aspect ratio of each MOS transistor of the plurality of MOS transistors connected in series is approximately equal to the channel aspect ratio of the first MOS transistor.

16. The current source of claim 14, wherein threshold voltage of each MOS transistor of the plurality of MOS transistors connected in series is approximately equal to the threshold voltage of the first MOS transistor.

17. A method for generating current with immunity for variation of threshold voltage, the method comprising:
providing a first MOS transistor for a first end of the first MOS transistor to be coupled to a voltage source;
providing a MOS transistor circuit to be coupled to the first MOS transistor and the voltage source;
providing a feedback circuit to be coupled to the voltage source, the feedback circuit comprising a feedback end coupled between the MOS transistor circuit and the first MOS transistor; and
inputting a control voltage to the feedback circuit for control a current with a predetermined magnitude passing through the MOS transistor circuit, as well as control a voltage of the feedback end, wherein the feedback end is coupled to a control end of the first MOS transistor.

18. The method of claim 17, wherein the MOS transistor circuit comprises a sixth MOS transistor, and the method further comprises:
adjusting channel aspect ratio of the sixth MOS transistor to be lower than channel aspect ratio of the first MOS transistor.

19. The method of claim 17, wherein the MOS transistor circuit comprises a sixth MOS transistor, and the method further comprises:
adjusting threshold voltage of the sixth MOS transistor to be higher than threshold voltage of the first MOS transistor.

20. The method of claim 17, wherein the MOS transistor circuit comprises a plurality of MOS transistors connected in series, and the method further comprises:
adjusting channel aspect ratio of every MOS transistor of the plurality of MOS transistors connected in series to approximately equal to channel aspect ratio of the first MOS transistor.
